(19) United States
(12) Patent Application Publication
(10) Pub. No.: US 2005/0078709 A1
(43) Pub. Date: Apr. 14, 2005

(54) Device and method for avoiding retraining processes in integrated voice and xdsl data transmission

(75) Inventor: Paul Kunisch, Puchheim (DE)

Correspondence Address: Siemens Corporation;Intellectual Property Department, 170 Wood Avenue South, Iselin, NJ, 08830, US

(73) Assignee: Siemens Aktiengesellschaft, 80333 Muenchen (DE)

(21) Appl. No.: 10/501,722

(22) PCT Filed: Jan. 28, 2003
(86) PCT No.: PCT/EP03/00838

(30) Foreign Application Priority Data
Jan. 28, 2002 (DE) 102 03 221.1

(51) Int. Cl. H04J 1/00

(52) U.S. Cl. 370/480; 370/493

(57) ABSTRACT

The invention relates to a data communication method and to a data communication device by way of which different signals can be exchanged with an additional data communicating device using one and the same line and utilizing different frequency ranges. The data communication device has a first signal exchange device that is activated if signals are to be exchanged with the additional data communication device utilizing a first frequency range, and a second signal exchange device that is used in order to exchange signals with the additional data communication device utilizing a second frequency range. The inventive method is further characterized in that the first signal exchange device is activated even if signals are to be exchanged with the additional data communication device using the second signal exchange device and utilizing the second frequency range, in order to avoid line impedance changes that otherwise occur when the first signal exchange device is activated or deactivated and that disturb the signal exchange via the second frequency range.

### CROSS REFERENCE TO RELATED APPLICATIONS

This application is the US National Stage of International Application No. PCT/EP03/00838, filed Jan. 28, 2003 and claims the benefit thereof. The International Application claims the benefits of German application No. 10203221.1 filed Jan. 28, 2002, both of the applications are incorporated by reference herein in their entirety.

### FIELD OF INVENTION

The invention relates to a data communication device and to data communication methods.

### BACKGROUND OF INVENTION

For transmitting data, transmission signals are transmitted over, for example, twisted pairs from a (first) data communication device, for example from a transmitting/receiving device, to one or more other data communication devices, for example to other transmitting/receiving devices, and vice versa. The (first) transmitting/receiving device can be, for example, an electronic module which is provided in an EWSD (EWSD: German abbreviation of “Electronic Switching System, Digital”) terminating switching center and has several modems (modem: modulator/demodulator).

Connected to each modem is a subscriber line, for example one or more twisted pairs, via which corresponding transmission signals are in each case transmitted to, for example, an electronic module provided on a subscriber termination (and via which corresponding transmission signals are transmitted from the subscriber termination module to the terminating switching center modem).

Data communication between the EWSD terminating switching center and subscriber termination can take place on the basis of, for example, POTS (Plain Old Telephone Service), ISDN (Integrated Services Digital Network), or xDSL (x Digital Subscriber Line) data transmission protocols, for example by means of ADSL data transmission or, as the case may be, according to the ITU G.992.1 (G.dmt) or, as the case may be, ITU G.992.2 (G.Lite) standards.

In the case of data communication according to an xDSL protocol, use is made of several frequency bands (bins) above those employed for POTS or, as the case may be, ISDN (voice) data transmission. For transmitting data in a specific frequency band it is possible to use, for example, a cosine oscillation whose frequency is located in, for example, the mid range of the corresponding frequency band.

As an example, each bit or bit sequence being transmitted can be allocated (making use, for example, of a constellation diagram) a cosine oscillation having a specific amplitude and phase. The respectively transmitted bit or, as the case may be, bit sequence can be determined in the receiving device from the amplitude and phase of the respectively received cosine oscillation.

In the case of integrated solutions for POTS or, as the case may be, ISDN (voice) data and DSL data transmission (referred to as integrated voice/data transmission), the POTS or, as the case may be, ISDN (voice) data path and DSL data path are located parallel to each other in the respective EWSD terminating switching center or, as the case may be, respective subscriber termination. To suppress mutual interference between the paths, the DSL data path is connected via a high-pass filter, for example a capacitance-coupled transformer, and the POTS or, as the case may be, ISDN (voice) data path is connected via a low-pass filter, for example a choke.

Provided the POTS or, as the case may be, ISDN (voice) data path does not change its operating state, which is to say as long as it remains in an activated or, as the case may be, deactivated mode, the input impedance of the EWSD terminating switching center or, as the case may be, subscriber termination will remain constant so that a DSL data connection can be set up without any problems and can be maintained without the need for retraining processes.

Conversely, a change in the operating mode of the POTS or, as the case may be, ISDN (voice) data path in the respective EWSD terminating switching center or, as the case may be, subscriber termination will result in a change in the input impedance of said switching center or, as the case may be, termination and hence to changes in the amplitude and phase of the cosine oscillations used for DSL transmission and received by the respective terminating switching center or, as the case may be, subscriber termination. Depending on the magnitude of the changes, this can lead to bit errors or may necessitate terminating and renewing the DSL data connection (referred to as “retraining”).

### SUMMARY OF INVENTION

The object of the invention is to make a novel kind of data communication device and novel kinds of data communication methods available.

The invention achieves these and further objectives by the claims. Advantageous developments of the invention are described in the dependent claims.

According to a basic concept of the invention, a data communication device is provided by means of which different signals can be exchanged with another data communication device using one and the same line and utilizing different frequency ranges, with said data communication device having a first signal exchange device, in particular a first interface device, that is activated if signals are to be exchanged with the other data communication device utilizing a first frequency range, and a second signal exchange device, in particular a second interface device, that is used in order to exchange signals with the other data communication device utilizing a second frequency range, characterized in that the first signal exchange device will be activated even if signals are to be exchanged with the other data communication device using the second signal exchange device and utilizing the second frequency range in order to avoid changes in line impedance that otherwise occur when the first signal exchange device is activated or deactivated and that disturb the signal exchange via the second frequency range.

According to a further aspect of the invention, a data communication device is provided by means of which different signals can be exchanged with another data communication device using one and the same line and utilizing different frequency ranges, with said data communication device having a first signal exchange device that is activated if signals are to be exchanged with the other data communication device utilizing a first frequency range, and a second signal exchange device that is used in order to exchange signals with the other data communication device utilizing a second frequency range, characterized in that the data communication device has a determining device by means of which it is determined whether changes in line impedance occurring when the first signal exchange device is activated or deactivated will lead to bit errors or an excessively high bit error rate during the signal exchange carried out using the second signal exchange device and utilizing the second frequency range.

Particular preference is accorded to an embodiment in which, when it is determined that changes in line impedance occurring when the first signal exchange device is activated or deactivated will lead to bit errors or an excessively high bit error rate, the first signal exchange device will be activated even if signals are to be exchanged with the other data communication device using the second signal exchange device and utilizing the second frequency range, and the first signal exchange device will otherwise only be activated if signals are to be exchanged with the other data communication device using the first signal exchange device and utilizing the first frequency range.

POTS voice signals, for example, can be transmitted via the first frequency range and DSL signals, for example, can be transmitted via the second frequency range as well as via other frequency ranges, for example a third, fourth, and fifth frequency range. These are coded by means of, for example, a QAM method.

Particular preference is accorded to an embodiment of the invention in which, when it is determined that changes in line impedance occurring when the first signal exchange device is activated or deactivated will lead to bit errors or an excessively high bit error rate, the allocation of bits or bit sequences to the second or third (DSL) frequency range (and/or the bit allocation to the other (DSL) frequency ranges) will be changed.

The invention is explained in more detail below with the aid of several exemplary embodiments and the attached drawing.

### BRIEF DESCRIPTION OF THE DRAWINGS

FIG. 1 is a schematic of a data communication system having transmitting/receiving devices according to the present invention;

FIG. 2 is a schematic of the frequency bands used by a transmitting/receiving device according to the invention for POTS or, as the case may be, ISDN and for DSL data transmission;

FIG. 3is a schematic of a constellation diagram used for DSL data transmission; and

FIG. 4is a detailed schematic of a transmitting/receiving device used in the case of the data communication system according to FIG. 1.

### DETAILED DESCRIPTION OF INVENTION

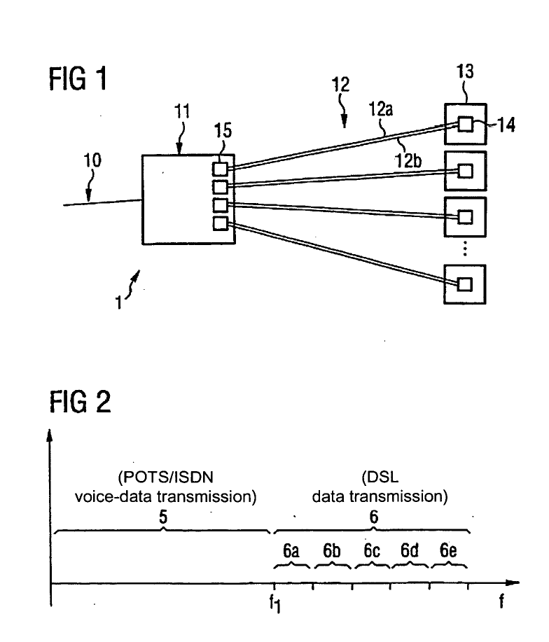

FIG. 1 shows an example of a data communication system 1 according to the present invention.

The data communication system 1 has a terminating switching center 11 (in this case an EWSD Electronic Switching System, Digital) connected to a telephone network (in this case the public telephone network 10). Provided in the terminating switching center 11 are a plurality of transmitting/receiving devices 15 each connected via subscriber lines 12, for example twisted pairs, to transmitting/receiving devices 14 located in subscriber termination devices 13. The twisted pairs consist in each case of two wires 12a, 12b. Differential or, as the case may be, symmetrical signals are used for transmitting data over the respective pairs.

Data communication between the transmitting/receiving devices 15 provided in the terminating switching center 11 and the transmitting/receiving devices 14 of the subscriber termination devices 13 takes place using POTS (Plain Old Telephone Service) or, as the case may be, ISDN (Integrated Services Digital Network) (voice) data transmission, and also using xDSL (x Digital Subscriber Line) data transmission.

According to FIG. 2, several frequency bands (bins) 6a, 6b, 6c, 6d that are above a frequency fl and are located within a frequency range 6 are employed for the xDSL data transmission. The frequency range 5 below the frequency fl is used for conventional POTS or, as the case may be, ISDN (voice) data transmission. The is approximately 25 to 35 kHz, in particular 30 kHz, in the case of POTS data transmission and approximately 130 kHz in the case of ISDN data transmission.

A QAM method, for example, can be used for DSL data transmission between corresponding terminating switching center transmitting/receiving devices 15 and subscriber transmitting/receiving devices 14 (and vice versa). Cosine oscillations whose frequencies can in each case be located in, for instance, the mid range of the corresponding frequency band 6a, 6b, 6c, 6d, 6e are here used for each frequency band 6a, 6b, 6c, 6d, 6e.

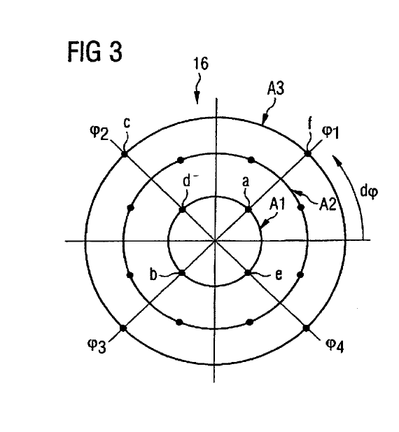

The data being transmitted can be coded in a cosine oscillation using, for instance, the constellation diagram 16 shown in FIG. 3. Said diagram has several concentric circles each assigned a cosine oscillation amplitude of a specific magnitude A1, A2, A3. Located on each circle—with in each case different angles φ1, φ2, φ3 or, as the case may be, φ4→are several (in this case 16) points a, b, c, d, e, f each allocated one of several different bits or bit sequences (in this case 16 different 4-bit sequences with, for example, bit sequence “1010” being allocated to point a and bit sequence “1010” being allocated to point b, etc.).

Each of the above-mentioned angles (φ1, φ2, φ 3 or, as the case may be, φ4 is assigned a corresponding phase shift of a cosine oscillation with reference to a clock running synchronously in the terminating switching center transmitting/receiving device 15 and subscriber transmitting/receiving devices 14 (or, as the case may be, with reference to a pilot tone transmitted by the respective transmitting/receiving device 14, 15).

Data transmission within the respective frequency band 6a, 6b, 6c, 6d (bins) can take place with the aid of, for example, a cosine oscillation via whose amplitude and phase shift in each case one of the above-mentioned bits or, as the case may be, bit sequences is identified. The respectively transmitted bit or, as the case may be, bit sequence can be determined in the respective transmitting/receiving device 14, 15—with the aid of a constellation diagram corresponding to the above-mentioned constellation diagram 16—from the amplitude and phase shift of the respectively received cosine oscillation.

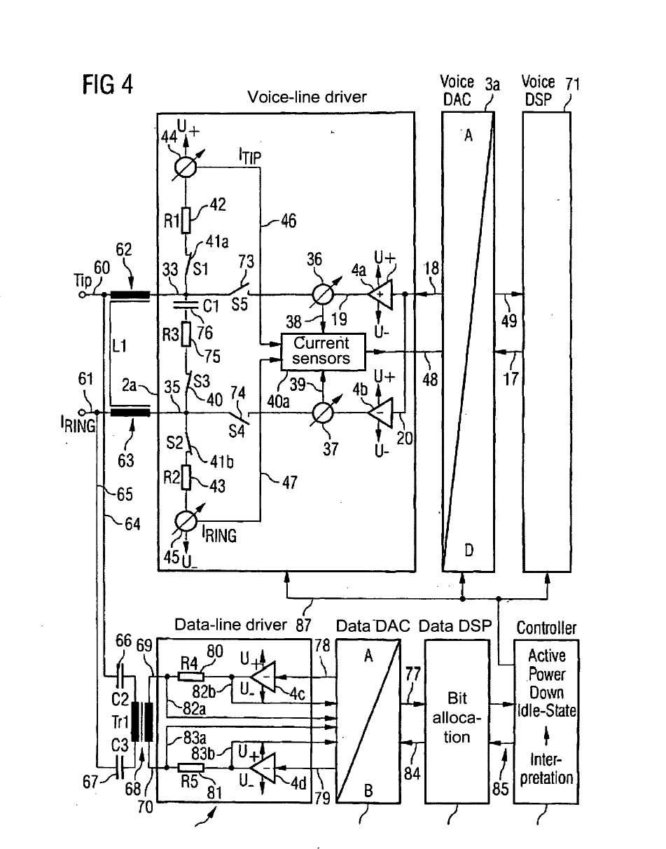

FIG. 4 is a detailed schematic of the transmitting/receiving device 14 provided in the subscriber termination device 13. The terminating switching center transmitting/receiving device 15 provided in the terminating switching center 11 and connected to the subscriber transmitting/receiving device 14 is structured analogously similarly to the subscriber transmitting/receiving device 14 shown in FIG. 4.

The subscriber transmitting/receiving device 14 has a TIP terminal and a RING terminal to which in each case one of the two wires 12a or, as the case may be, 12b of the above-mentioned subscriber line 12 is connected.

The TIP terminal and RING terminal are each connected via two lines 60, 61 to a choke 62, 63. The chokes 62, 63 are connected via two lines 33, 35 to a voice-data interface circuit 2a (in this case an SLIC Subscriber Line Interface Circuit) or, as the case may be, to a voice-line driver circuit 2a.

By means of the low-pass filter formed by the chokes 62, 63 it is ensured that when the voice-data interface circuit 2a (see below) is in the active operating mode, preferably—which is to say in accordance with the frequency-dependant attenuation—the only signals forwarded to the voice-data interface circuit 2a are those whose frequency is below the above-mentioned frequency fl (approximately 30 kHz), which is to say with which conventional POTS or, as the case may be, ISDN data is transmitted (see FIG. 2).

According to FIG. 4, the TIP terminal and RING terminal are furthermore each connected via two further lines 64, 65 to a capacitor 66, 67. The first capacitor 66 is connected to a first terminal of a transformer 68 and the second capacitor 67 is connected to a second terminal of the transformer 68. The transformer 68 is connected via two lines 69, 70 to a DSL-data interface circuit 2b or, as the case may be, to a data-line driver circuit 2b.

By means of the high-pass filter formed by the capacitors 66, 67 and the transformer 68 it is ensured that preferably which is to say in accordance with the frequency-dependant attenuation—the only signals forwarded to the DSL-data interface circuit 2b are those whose frequency is above the above-mentioned frequency fl (approximately 30 kHz), which is to say those signals with which DSL data is transmitted (see FIG. 2).

The transformer 68 must be free of direct current because it must not short-circuit the feeding direct current or ringing current in the voice-data interface circuit 2a.

As is further shown in FIG. 4, the voice-data interface circuit 2a is connected to an analog/digital converting device 3a which is in turn connected to a digital signal processor DSP (DSP: Digital Signal Processor) 71 (“voice path”).

The DSL-data interface circuit 2b is analogously connected to an analog/digital converting device 3b which is in turn connected to a digital signal processor 72 (“data path”).

For transmitting DSL data the digital data signal respectively being transmitted, for example an appropriately converted signal of such type sent out by a corresponding computer, is routed via a line 84 from the digital signal processor 72 to the analog/digital converting device 3b, converted there into an analog data signal, and forwarded via corresponding lines 78, 79 to the interface circuit 2b.

In the interface circuit 2b the signal made available via the line 78 is amplified in a first signal amplifying device 4c and the signal made available via the line 79 is amplified in a second signal amplifying device 4d so that—with resistors 80, 81 connected to the above-mentioned lines 69, 70 being inserted intermediately—the corresponding differential or, as the case may be, symmetrical data signals will then be fed out at the outputs of the interface circuit 2b (and hence finally on the TIP/RING terminal pair) by the signal amplifying devices 4c, 4d.

For receiving DSL data the magnitude of the currents flowing on the lines 64, 65 connected to the TIP or, as the case may be, RING terminal (or, as the case may be, quantities representing said currents) is measured by the interface circuit 2b.

For this purpose the current flowing through the resistor 80 (or, as the case may be, the resistor 81) is tapped in the interface circuit 2b by means of two lines 82a, 82b (or, as the case may be, with the aid of two lines 83a, 83b) and the corresponding signals are routed via the lines 82a, 82b (or, as the case may be, 83a, 83b) to the analog/digital converting device 3b. The analog data signals are appropriately converted there and a digital signal corresponding to the received DSL signal is routed via a line 77 to the digital signal processor 72.

This allows sampling of any DSL data signals sent from the terminating switching center 11 via the wire pair 12a, 12b to the subscriber termination device 13 and from the termination device 13 to the terminating switching center 11.

For transmitting POTS or, as the case may be, ISDN (voice) data the digital (voice) data signal respectively being transmitted, for example an appropriately converted signal of such type sent out by a telephone microphone, is routed via a line 17 from the digital signal processor 71 to the analog/digital converting device 3a, converted there into an analog (voice) data signal, and forwarded via a line 18 to the interface circuit 2a.

In the interface circuit 2a the (voice) data signal is routed via a line 19 to a first signal amplifying device 4a (for example an operational amplifier) and via a line 20 to a second signal amplifying device 4b (for example an operational amplifier).

As is explained in greater detail below, the first signal amplifying device 4a is connected via a switch 73 to the line 33, and hence via the choke 62 to the TIP terminal, and the second signal amplifying device 4b is connected via a switch 74 to the line 35, and hence via the choke 63 to the RING terminal, so that when the switches 73, 74 are in a closed, which is to say conducting state (“active operating mode”), the corresponding differential or, as the case may be, symmetrical (voice) data signals can then be applied by the signal amplifying devices 4a, 4b to the TIP/RING terminal pair.

The magnitude of the currents flowing on the lines 33, 35 connected to the TIP or, as the case may be, RING terminal are measured in the active operating mode by current sensor devices 36, 37.

The first current sensor device 36 is connected between the first signal amplifying device 4a and the switch 73 and the second current sensor device 37 is connected between the second signal amplifying device 4b and the switch 74.

The current sensor devices 36, 37 supply a signal representing the magnitude of the respectively flowing current to a control unit 40a via corresponding lines 38, 39.

This allows any analog POTS or, as the case may be, ISDN (voice) data signals sent from the terminating switching center 11 via the wire pair 12a, 12b to the subscriber termination device 13 and from the termination device 13 to the terminating switching center 11 to be sampled and forwarded via a line 48 to the analog/digital converting device 3a at whose output a digital (voice) signal (“voice”) is then made available which is forwarded to the digital signal processor 71 via a line 49.

During transition from the active to the passive operating mode the switches 73, 74 are, as explained in greater detail below, put into a non-conducting state and a further switch 41a connected to the line 33 as well as two further switches 40, 41b connected to the line 35 are put into a closed, which is to say conducting state.

The first switch 41a is connected—apart from to the line 33 connected to the TIP terminal—to a first high-value resistor 42 (in this case a resistor having a resistance R1 of from 1 to 10 kΩ). The second switch 41b is analogously connected—apart from to the line 35 connected to the RING terminal—to a second high-value resistor 43 (in this case a resistor having a resistance R2 of from 1 to 10 kΩ).

The first resistor 42 is connected to a current sensor device 44, which is in turn connected to a positive supply voltage U., and the second resistor 43 is connected to a current sensor device 45, which is in turn connected to a negative supply voltage U.

When the switches 41a, 41b have closed, a current can flow from the positive supply voltage U+via the current sensor device 44, the first resistor 42, and the first switch 41a to the with line 33 connected to the TIP terminal, from said line to the line 35 connected to the RING terminal, and via the second switch 41b, the second resistor 43, and the current sensor device 45 on to the negative supply voltage U.

The magnitude of the currents flowing through the first or, as the case may be, second resistor 42, 43 is measured by the current sensor devices 44, 45. Said devices supply a signal representing the magnitude of the respectively flowing current to the control unit 40a via corresponding lines 46, 47 (sampling of the wires 12a, 12b in the passive operating mode).

As is further shown in FIG. 4, the above-mentioned switch 40 is connected—apart from to the line 35 connected to the RING terminal—to a resistor 75 which is in turn connected via a capacitor 76 to the line 33 connected to the TIP terminal.

The RC combination comprising the resistor 75 and the capacitor 76 is dimensioned such that the input impedance of the voice-data interface circuit 2a is (as far as possible) identical or, as the case may be, substantially identical in the passive operating mode to its input impedance in the active operating mode (an input impedance is synthesized there in the line drivers 4a and 4b which has a cut-off frequency fl of approximately 30 kHz and which assumes approximately the value of R75 for higher frequencies).

The remaining, minor change in impedance occurring during switchover between operating modes is due partly to component tolerances. Said change in impedance impacts especially on those frequency bands or, as the case may be, bins 6a, 6b used for DSL data transmission where the respectively transmitted cosine oscillations have a relatively low frequency (because the impedance of the chokes 62, 63 is relatively low in the case of these frequencies).

The remaining change in impedance is so small that the resulting changes in the amplitude of the transmitted cosine oscillations are <0.1 dB and the resulting phase changes are <100.

It is nevertheless conceivable for amplitude and phase changes of said type to be sufficiently large to lead to bit errors and/or necessitate terminating and renewing the DSL data connection (referred to as “retraining”).

To avoid bit errors or, as the case may be, retraining processes, the method described below (Method I), for example, is used for the transmitting/receiving device 14 shown here (and analogously also for the transmitting/receiving device 15, for example):

When the DSL data connection (training phase) is being set up, according to the DSL standard each frequency band 6a, 6b, 6c, 6d (bin) is allocated (for example under the control of the digital signal processor 72) a specific number of bits or, as the case may be, bit sequences (see the constellation diagram 16 shown in FIG. 3), as a function of the signal-to-noise ratio applying to the respective frequency band 6a, 6b, 6c, 6d (bin) shown in FIG. 2.

(For estimating the signal-to-noise ratio [SNR], reference data can be transmitted[likewise under the control of the digital signal processor 72] from, for example, the transmitting/receiving device 14 via the wire pair 12a, 12b to the transmitting/receiving device 15, and compared there with comparison data previously stored in the transmitting/receiving device 15.)

The more bits or, as the case may be, bit sequences there are allocated to a specific frequency band 6a, 6b, 6c, 6d (bin), the smaller will be the spacing between sets of two valid code words and the greater will be the chance that the above-mentioned changes in amplitude and phase occurring during switchover between operating modes will lead to bit errors and/or necessitate terminating and renewing the DSL data connection.

In the case of the transmitting/receiving device 14 shown here it is determined in advance for each frequency band 6a, 6b, 6c, 6d (bin) used—for example by performing a corresponding simulation in the digital signal processor 72—how large the above-mentioned changes are in cosine oscillation amplitude and phase occurring during switchover between operating modes.

This is done taking account of the transmission characteristics of the voice path, data path, and respective transmission channel. (The transmission characteristics of the transmission channel can be determined by, for example, sending out test signals under the control of the digital signal processor 72 from the transmitting/receiving device 14 at the wires 12a, 12b and measuring the corresponding echo signals and/or evaluating the test signals sent in the transmitting/receiving device 15.)

The ascertained magnitude of the changes in cosine oscillation amplitude and phase occurring during switchover between operating modes will then be used to determine whether or not the change in impedance will lead to bit errors and/or necessitate terminating and renewing the DSL data connection.

If it is determined that the change in impedance would lead to bit errors and/or necessitate terminating and renewing the DSL data connection (and if the bit allocation must remain unchanged), then—regardless of whether or not POTS or, as the case may be, ISDN (voice) data transmission is about to be effected—(shortly) before DSL data is transmitted the voice path will be put into the above-mentioned active operating mode (which is to say the switches 73, 74 will be put into a conducting state and the switch 41a as well as the switches 40, 41b will be put into a non-conducting state).

Only at this point does DSL data transmission commence, which is to say only then is the first DSL metaframe sent. (According to the DSL protocol, DSL data transmission takes place in each case within predefined time slices, which is to say within specific frames, with several[for example 69] different frames each of a predefined duration being combined into one metaframe [followed by a further metaframe structured analogously to the first, etc.]. The metaframes can each be of, for example, 10 to 25 ms—in particular approximately 17 ms—duration. According to the DSL protocol the first frame of the respective metaframe is what is termed a synchronizing frame that is followed by several [for example 68] [useful] data frames.)

Alternatively, not the entire voice path (which is to say the voice-data interface circuit 2a, the analog/digital converting device 3a, and the signal processor 71) is put into the above-mentioned active state prior to the start of DSL data transmission but, instead, only parts thereof, for example only the voice-data interface circuit 2a (high-voltage SLIC 2a[SLIC: Subscriber line interface circuit]) or, as the case may be, those parts required for impedance synthesis in the high-voltage SLIC or, as the case may be, in the interface circuit 2a—by, for example, dc-isolating said parts from the others after closing of the switches 73, 74 by switching over corresponding further switches.

Power dissipation in the voice path can be reduced by said means.

(Shortly) following completion of DSL transmission (which is to say when the last of the above-mentioned, successively sent metaframes has been sent) the voice path (or the above-mentioned parts thereof) will be returned to the above-mentioned passive operating mode (which is to say the switches 73, 74 will be returned to a non-conducting state and the switch 41a as well as the switches 40, 41b will be returned to a conducting state)—unless pots or, as the case may be, isdn (voice) data transmission now has to be carried out.

To effect the above-described changeover of the voice path or, as the case may be, corresponding parts thereof into the above-mentioned active or, as the case may be, passive state, corresponding control signals are supplied by the digital signal processor 72 via a line pair 85 to a controller 86 which, by transmitting corresponding activating or, as the case may be, deactivating control signals via lines 87, then correspondingly activates or, as the case may be, deactivates the voice path or, as the case may be, the voice-data interface circuit 2a, the analog/digital converting device 3a, and the signal processor 71.

Alternatively or in addition to the above-explained method the following method is also employed for the transmitting/receiving device 14 shown here (and analogously also for, for example, the transmitting/receiving device 15) to avoid bit errors or, as the case may be, retraining processes (method II):

If, as explained above, it is determined by the digital signal processor 72 that the change in impedance occurring during changeover between voice path operating modes would lead to bit errors and/or necessitate terminating and renewing the DSL data connection, the bit allocation will be changed by the digital signal processor 72.

This is possible because DSL data can generally be transmitted via the wires 12a, 12b at a much faster data rate than is permitted by the respective network provider.

For this reason, in many cases not as many bits have to be allocated to a specific frequency band 6a, 6b, 6c, 6d (bin) as would actually be possible according to the respective signal-to-noise ratio.

It is possible, therefore, for the digital signal processor 72 to remove from frequency bands 6a, 6b, 6c, 6d (bins) bits originally allocated to them in the case of which the change in impedance occurring during changeover between voice path operating modes would lead to bit errors (preferably from frequency bands 6a in the lower frequency range).

Said bits can then be allocated to frequency bands 6a, 6b, 6c, 6d (bins) to which, according to the above-mentioned signal-to-noise ratio, (actually) more bits can be allocated than originally took place (preferably to frequency bands 6d in the upper frequency range).

The digital signal processor 72 then performs another simulation and determines the magnitude, after the bit allocation has been changed for each frequency band 6a, 6b, 6c, 6d (bin) used, of the above-mentioned changes occurring in cosine oscillation amplitude and phase during changeover between operating modes or, as the case may be, whether or not the change in impedance will lead to bit errors and/or necessitate terminating and renewing the DSL data connection.

If so, the allocation of the bits to the individual frequency bands 6a, 6b, 6c, 6d will, if applicable, be changed again etc., and/or the above-described first bit error avoidance method (Method I) will alternatively then be carried out.

1-10. (canceled)

11. a data communication device adapted to exchange different signals with another data communication device using one and the same line and utilizing different frequency ranges, the data communication device comprising:
a first signal exchange device that is activated if signals are to be exchanged with the other data communication device utilizing a first frequency range; and
a second signal exchange device that is used in order to exchange signals with the other data communication device utilizing a second frequency range, wherein
the first signal exchange device will be activated even if signals are to be exchanged with the other data communication device using the second signal exchange device and utilizing the second frequency range in order to avoid changes in line impedance that otherwise occur when the first signal exchange device is activated or deactivated and that disturb the signal exchange via the second frequency range.

12. The data communication device according to claim 11, further comprising:
a determining device adapted to determine whether changes in line impedance occurring when the first signal exchange device is activated or deactivated will lead to bit errors or an high bit error rate during the signal exchange carried out using the second signal exchange device and utilizing the second frequency range.

13. The data communication device according to claim 12 in which, when it is determined that changes in line impedance occurring when the first signal exchange device is activated or deactivated will lead to bit errors or an high bit error rate, the first signal exchange device will be activated even if signals are to be exchanged with the other data communication device using the second signal exchange device and utilizing the second frequency range, and the first signal exchange device will otherwise only be activated if signals are to be exchanged with the other data communication device using the first signal exchange device and utilizing the first frequency range.

14. The data communication device according to claim 11, wherein not the entire first signal exchange device but, instead, only a part thereof is activated in order to avoid changes in line impedance that occur when the first signal exchange device is activated or deactivated and that disturb the signal exchange via the second frequency range.

15. The data communication device according to claim 12, wherein not the entire first signal exchange device but, instead, only a part thereof is activated in order to avoid changes in line impedance that occur when the first signal exchange device is activated or deactivated and that disturb the signal exchange via the second frequency range.

16. The data communication device according to claim 13, wherein not the entire first signal exchange device but, instead, only a part thereof is activated in order to avoid changes in line impedance that occur when the first signal exchange device is activated or deactivated and that disturb the signal exchange via the second frequency range.

17. The data communication device according to claim 11 in which for exchanging data using the second frequency range and for exchanging data using a third frequency range each of said frequency ranges is allocated a specific number of bits or bit sequences.

18. The data communication device according to claim 12 in which for exchanging data using the second frequency range and for exchanging data using a third frequency range each of said frequency ranges is allocated a specific number of bits or bit sequences.

19. The data communication device according to claim 13 in which for exchanging data using the second frequency range and for exchanging data using a third frequency range each of said frequency ranges is allocated a specific number of bits or bit sequences.

20. The data communication device according to claim 14 in which for exchanging data using the second frequency range and for exchanging data using a third frequency range each of said frequency ranges is allocated a specific number of bits or bit sequences.

21. The data communication device according to claim 20 in which, when it is determined that changes in line impedance occurring when the first signal exchange device is activated or deactivated will lead to bit errors or an excessively high bit error rate, the allocation of bits or bit sequences to the second or third frequency range will be changed.

22. The data communication device according to claim 20, wherein the transmission signals used for exchanging data are DSL signals.

23. The data communication device according to claim 21, wherein the transmission signals used for exchanging data are DSL signals.

24. The data communication device according to claim 11, wherein the signals sent using the first frequency range are voice signals.

25. The data communication device according to claim 12, wherein the signals sent using the first frequency range are voice signals.

26. A data communication device adapted to exchange different signals with another data communication device using one and the same line and utilizing different frequency ranges, the data communication device comprising:
a first signal exchange device that is activated if signals are to be exchanged with the other data communication device utilizing a first frequency range;
a second signal exchange device that is used in order to exchange signals with the other data communication device utilizing a second frequency range; and
a determining device for determining whether changes in line impedance occurring when the first signal exchange device is activated or deactivated will lead to bit errors or an high bit error rate during the signal exchange carried out using the second signal exchange device and utilizing the second frequency range.

27. A method for data communication, comprising:
activating a first signal exchange device if signals are to be exchanged via a line using a first frequency range; and
determining whether changes in line impedance occurring when the first signal exchange device is activated or deactivated will lead to bit errors or an high bit error rate during a signal exchange carried out via the same line using a second signal exchange device and utilizing a second frequency range.

28. A method for data communication, comprising:
activating a first signal exchange device if signals are to be exchanged via a line using a first frequency range; and
activating the first signal exchange device even if signals are to be exchanged via the line using a second signal exchange device and utilizing a second frequency range in order to avoid changes in line impedance that otherwise occur when the first signal exchange device is activated or deactivated and that disturb the signal exchange via the second frequency range.
